(19) United States
(12) Patent Application Publication
(10) Pub. No.: US 2014/0363240 A1
(43) Pub. Date: Dec. 11, 2014

(54) Method and Composition For Consolidating and Mechanically Strengthening Soil and/or Sand

(71) Applicants: George W. Putman, Saratoga Springs, NY (US); David G. Putman, Ballston Spa, NY (US); Geoffrey D. Putman, Ballston Spa, NY (US)

(72) Inventors: George W. Putman, Saratoga Springs, NY (US); David G. Putman, Ballston Spa, NY (US); Geoffrey D. Putman, Ballston Spa, NY (US)

(21) Appl. No.: 13/913,481

(22) Filed: Jun. 9, 2013

(51) Int. Cl. C09K 17/12; E02D 3/12

(52) U.S. Cl. CPC C09K 17/12; E02D 3/12
USPC 405/266; 106/633

(57) ABSTRACT

A composition and method for consolidating and mechanically strengthening soil and/or sand, comprising: a) preparing a dry mixture, comprising: the soil and/or sand, CaCl₂ or CaO, and alumina, wherein 100 parts of the dry mixture comprises 1-99 parts soil and/or sand, 0-25 parts CaCl₂, and 0-25 parts alumina; and b) adding aqueous Na₂SiO3, wherein 100 parts v/v of the aqueous Na₂SiO₃ comprises 1-35 parts Na₂SiO₃, and 99 to 65 parts water; and repeating steps a and b until refusal occurs. Alternatively, a composition for consolidating and mechanically strengthening soil and/or sand, comprising: 100 parts of a dry mixture, comprising: 99-1 parts of the soil and/or sand; 0-25 parts alumina; 0-35 parts silicate; and 0-25 parts CaCl₂. The silicate may be Na₂Si₂O₃, Li₂Si₂O₃, and K₂Si₂O₃.

### BACKGROUND

1.1. Technical Field

The present invention relates to methods and compositions for treating soil and/or sand, resulting in consolidation and mechanical strengthening. More specifically, the present invention relates to methods and compositions for treating soil and/or sand by forming a dry mixture that includes the soil and/or sand, calcium chloride (CaCl₂) and alumina (aluminum oxide, Al₂O₃); then reacting the mixture with aqueous sodium silicate.

1.2. Related Art

In nature, the lithification of unconsolidated materials commonly occurs by the infilling of intergranular void space with interstitial material deposited from solution as mineral overgrowths and cements. This loss of void space progressively decreases the primary permeability and could reduce it to insignificance.

Related methods of treatment of ground and earth strata includes U.S. Pat. No. 4,869,621, issued on Sep. 26, 1989 to McLaren et al. for METHOD OF SEALING PERMEABLE EARTH SURFACE OR SUBSURFACE MATERIALS HAVING ALKALINE CONDITIONS BY INDUCED PRECIPITATION OF CARBONATES. McLaren et al. propose a method of artificially sealing voids in earth strata under alkaline conditions by inducing precipitation, via pumped slurries of aqueous solutions which may include finely divided solids, for example, of calcium carbonate, usually in the form of calcite.

U.S. Pat. No. 4,981,394, issued on Jan. 1, 1991 to McLaren et al. for METHOD OF SEALING PERMEABLE UNCONSOLIDATED MATERIALS. McLaren et al. propose a method for forming solid layers or local zones of material of decreased permeability upon or below the earth's surface and above the water table to inhibit the flow of groundwaters or surface precipitation through such layers of materials.

U.S. Pat. No. 7,381,014, issued on Jun. 3, 2008 to Bird et al., disclose a Natural Analog System (NAS). The NAS process is a method of precipitating calcium carbonate cement in the ground that duplicates natural geologic cementing mechanisms. Calcium carbonate, the artificially produced product of the process, is analogous to the naturally produced calcium carbonate cements of sedimentary rock.

Nevertheless, there is a need for developing methods and compositions to recycle waste products into new, usable products.

### SUMMARY OF THE INVENTION

A first aspect of the present invention provides a method for consolidating and mechanically strengthening soil and/or sand, comprising: a) Preparing a dry mixture, comprising: the soil and/or sand, CaCl₂ or CaO, and alumina, wherein 100 parts of the dry mixture comprises 1-99 parts soil and/or sand, 0-25 parts CaCl₂ or CaO, and 0-25 parts alumina; and b) adding aqueous silicate, wherein 100 parts of the aqueous silicate comprises 1-35 parts silicate, and 99 to 65 parts water; and c) repeating steps a and b until refusal occurs.

A second aspect of the present invention provides a method for consolidating and mechanically strengthening soil and/or sand, comprising: a) preparing a dry mixture comprising: the soil and/or sand, alumina, and CaCl₂, wherein 100 parts of the dry mixture comprises 1-99 parts soil and/or sand, 0-25 parts CaCl₂ or CaO, and 0-25 parts alumina, wherein the dry mixture does not contain compounds selected from the group consisting of CaO, Ca(OH)₂, MgO, and Mg(OH)₂; b) adding aqueous silicate, wherein 100 parts of the aqueous silicate comprises 1 to 35 parts silicate, and 99 to 65 parts water; and c) repeating steps 1 and 2 until refusal occurs, so that the mixture or treated mass becomes solidified, wherein substantially no concrete, as defined in the trade or commercially as a product by reactions with lime (CaO), is formed.

A third aspect of the present invention provides a composition for consolidating and mechanically strengthening soil and/or sand, comprising: 100 parts of a dry mixture, comprising: 99-1 parts of the soil and/or sand; 0-25 parts alumina; and 0-25 parts CaCl₂, wherein the dry mixture does not contain compounds selected from the group consisting of CaO, Ca(OH)₂, MgO, and Mg(OH)₂; and 100 parts of aqueous silicate, comprising: 1-35 parts silicate; and 99 to 65 parts water.

A fourth aspect of the present invention provides a composition for consolidating and mechanically strengthening soil and/or sand, comprising: 100 parts of a dry mixture, comprising: 99-1 parts of the soil and/or sand; 0-25 parts alumina; and 0-25 parts CaCl₂, and 100 parts of aqueous silicate, comprising: 1-35 parts silicate; and 99 to 65 parts water.

A fifth aspect of the present invention provides a method for consolidating and mechanically strengthening soil and/or sand, comprising: a) preparing a dry mixture, comprising: the soil and/or sand, CaCl₂ or CaO, silicate and alumina, wherein 100 parts of the dry mixture comprises 1-99 parts soil and/or sand, 0-25 parts CaCl₂ or CaO, 0-25 parts alumina; and 1-35 parts silicate, and b) percolating water through the mixture; and c) repeating steps a and b until refusal occurs.

A sixth aspect of the present invention provides a composition for consolidating and mechanically strengthening soil and/or sand, comprising: 100 parts of a dry mixture, comprising: 99-1 parts of the soil and/or sand; 0-25 parts alumina; 0-35 parts silicate; and 0-25 parts CaCl₂.

### BRIEF DESCRIPTION OF THE FIGURES

The features of the invention are set forth in the appended claims. The invention itself, however, will be best understood by reference to the following detailed description of an illustrative embodiment when read in conjunction with the accompanying drawings, wherein:

FIGS. 1-3 depict flow diagrams of methods for consolidating and mechanically strengthening soil and/or sand, in accordance with embodiments of the present invention.

### DETAILED DESCRIPTION OF THE EMBODIMENTS OF THE INVENTION

Loose, unconsolidated soil and/or sand may be advantageously consolidated and strengthened mechanically by reaction of the soil and/or sand with calcium chloride (CaCl₂), alumina (aluminum oxide, Al₂O₃) and a silicate, wherein the silicate is selected from the group consisting of lithium silicate, potassium silicate, or sodium silicate.

Silicates exist as lithium, potassium, sodium salts or mixtures thereof of silica. Sodium silicate is a common name for silica in aqueous NaOH, also known as sodium metasilicate, Na₂SiO₃, also known as waterglass or liquid glass. It is available in aqueous solution, in a solution with NaOH and water, and in solid form, as anhydrous sodium silicate.

Anhydrous sodium silicate contains a chain polymeric anion composed of corner shared {SiO₄} tetrahedra, and not a discrete SiO₃²⁻ ion. In addition to the anhydrous form, there are hydrates with the formula Na₂SiO₃.nH₂O (where n=5, 6, 8, 9) which contain the discrete, approximately tetrahedral anion SiO₂(OH)₂²⁻ with water of hydration. For example, the commercially available sodium silicate pentahydrate Na₂SiO₃.5H₂O is formulated as Na₂SiO₂(OH)₂.4H₂O and the nonahydrate Na₂SiO₃.9H₂O is formulated as Na₂SiO₂(OH)₂.8H₂O.

In industry, the various grades of sodium silicate are characterized by their SiO₂:Na₂O ratio, which can vary between 2:1 and 3.75:1. Grades with this ratio below 2.85:1 are termed ‘alkaline’. Those with a higher SiO₂:Na₂O ratio are described as ‘neutral’.

Definitions:

Hereinafter, unless defined otherwise, the term “silicate” refers to silicate salts derived from reaction of NaOH, LiOH or KOH with SiO₂, or from reaction of Na₂CO₃, Li₂CO₃, or K₂CO₃ with SiO₂ in their anhydrous or hydrated forms. Alkali silicate may be dissolved in water, e.g., as aqueous sodium silicate, or dissolved in aqueous NaOH. Solutions having 15 to 30 percent w/w sodium silicate may be provided in water or NaOH. The silicate solutions preferably have a viscosity range of 1-100 cps at 20° C., more preferably having a viscosity in the range of 1-10 cps at 20° C., and most preferably having a viscosity in the range of 1-5 cps at 20° C., since percolation of the silicate solution by gravity feed through unconsolidated soil and/or sand to achieve the desired consolidation and mechanical strength of the soil and/or sand is inversely proportional to the viscosity of the silicate solution at the temperature of the soil and/or sand. The soil and/or sand, thus treated, may thereby support travel over the consolidated and mechanically strengthened soil and/or sand by heavy machinery or equipment without the heavy machinery or equipment sinking into the surface of the soil and/or sand.

Hereinafter, unless defined otherwise, the term “low level radioactive waste (LLW)” is defined as nuclear waste that does not fit into the categorical definitions for intermediate-level radioactive waste (ILW), high-level radioactive waste (HLW), spent nuclear fuel (SNF), transuranic waste (TRU), or certain byproduct materials known as 11e(2) wastes, such as uranium mill tailings. In essence, it is a definition by exclusion, and LLW is that category of radioactive wastes that do not fit into the other categories. If LLW is mixed with hazardous wastes, then it has a special status as mixed low-level waste (MLLW) and must satisfy treatment, storage, and disposal regulations both as LLW and as hazardous waste. While the bulk of LLW is not highly radioactive, the definition of LLW does not include references to its activity, and some LLW may be quite radioactive, as in the case of radioactive sources used in industry and medicine.

The definition of low-level waste is set by the nuclear regulators of individual countries, though the International Atomic Energy Agency (IAEA) provides recommendations. Some countries, such as France, specify categories for long-lived low- and intermediate-level waste.

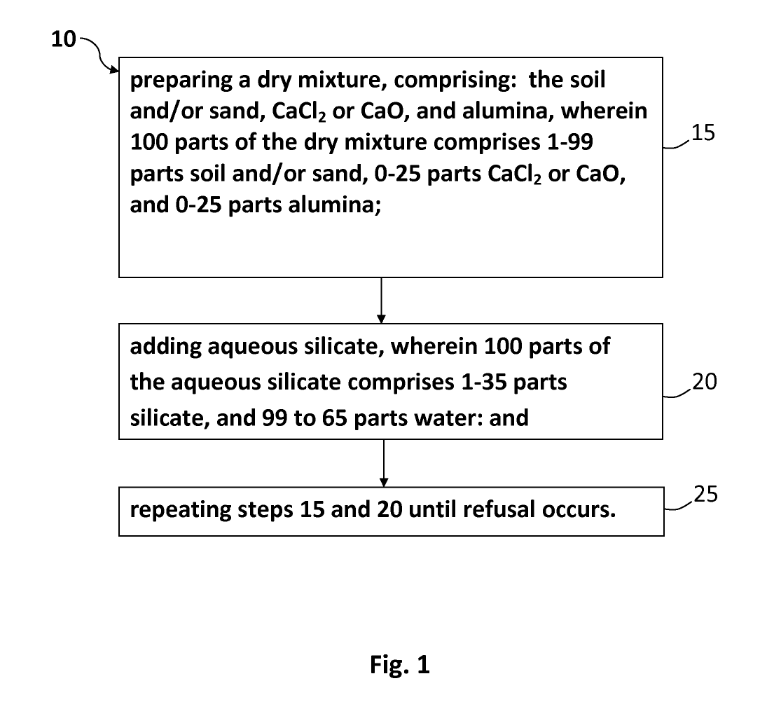

FIG. 1 depicts a flow diagram of a method 10 for consolidating and mechanically strengthening soil and/or sand. In a step 15, a dry mixture is prepared, comprising: the soil and/or sand, CaCl₂ or CaO, and alumina, wherein 100 parts of the dry mixture comprises 1-99 parts soil and/or sand, 0-25 parts CaCl₂ or CaO, and 0-25 parts alumina. In a step 20, aqueous silicate is added, wherein 100 parts of the aqueous silicate comprises 1-35 parts silicate, and 99 to 65 parts water. In a step 25, steps 15 and 20 are repeated until refusal occurs.

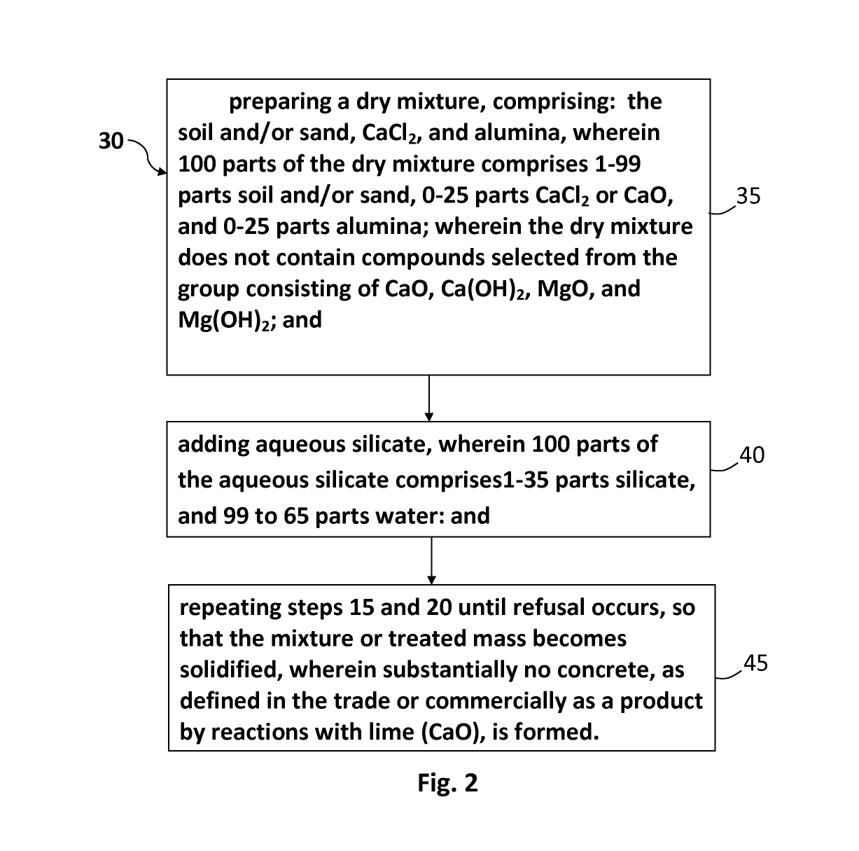

FIG. 2 depicts a flow diagram of a method 30 for consolidating and mechanically strengthening soil and/or sand. In a step 35, a dry mixture is prepared, comprising: the soil and/or sand, CaCl₂ or CaO, and alumina, wherein 100 parts of the dry mixture comprises 1-99 parts soil and/or sand, 0-25 parts CaCl₂ or CaO, and 0-25 parts alumina, wherein the dry mixture does not contain compounds selected from the group consisting of CaO, Ca(OH)₂, MgO, and Mg(OH)₂. In a step 40, aqueous silicate is added, wherein 100 parts of the aqueous silicate comprises 1-35 parts silicate, and 99 to 65 parts water. In a step 45, steps 35 and 40 are repeated until refusal occurs, so that the mixture or treated mass becomes solidified, wherein substantially no concrete, as defined in the trade or commercially as a product by reactions with lime (CaO), is formed.

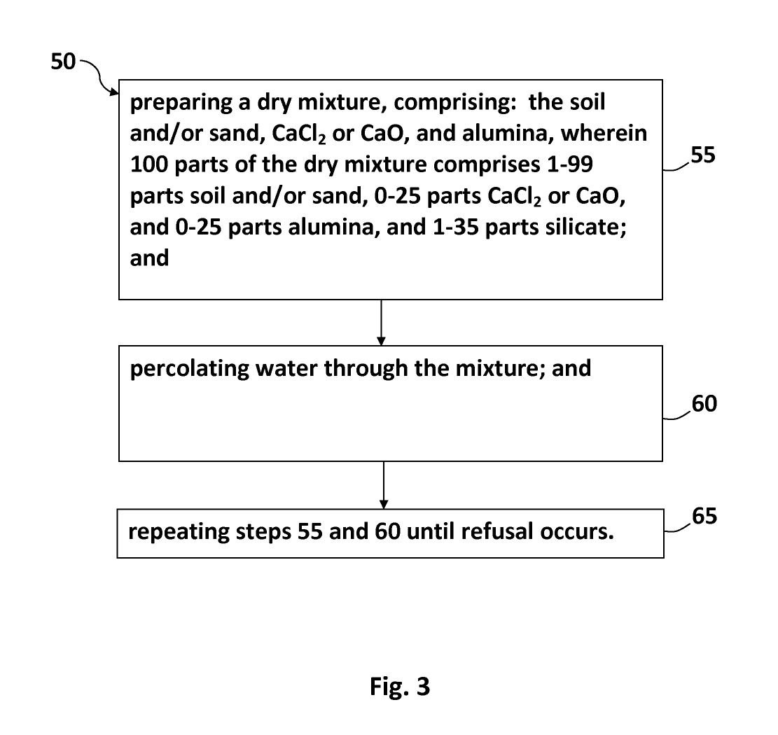

FIG. 3 depicts a flow diagram of a method 50 for consolidating and mechanically strengthening soil and/or sand. In a step 55, a dry mixture is prepared, comprising: the soil and/or sand, CaCl₂ or CaO, and alumina, wherein 100 parts of the dry mixture comprises 1-99 parts soil and/or sand, 0-25 parts CaCl₂ or CaO, 0-25 parts alumina, and 1-35 parts silicate. In a step 60, water is percolated through the mixture. In a step 65, steps 55 and 60 are repeated until refusal occurs.

The treatment, when the reactants are combined properly, yields a product that demonstrates significant mechanical rigidity as compared to untreated soil of the same type. In addition, the consolidated soil becomes highly impervious or impermeable to liquids.

In one embodiment, the calcium chloride in the mixture may be in the form of a dry salt and the sodium silicate may be provided as an aqueous solution, e.g., 15%-30% by weight in aqueous NaOH, as is prepared commercially.

Alternatively, the aqueous solution of sodium silicate may be made by dissolving 1 to 38 parts crystalline or powdered sodium silicate in its hydrated form in water and may be that which is commonly known commercially as water glass.

In one embodiment, a composition for consolidating and mechanically strengthening soil and/or sand comprises: 100 parts of a dry mixture, comprising: 99-1 parts of the soil and/or sand; 0-25 parts alumina; 0-35 parts silicate; and 0-25 parts CaCl₂.

In one embodiment, a composition for consolidating and mechanically strengthening soil and/or sand, comprises: 100 parts of a dry mixture, comprising: 99-1 parts of the soil and/or sand; 0-25 parts alumina; and 0-25 parts CaCl₂, wherein the dry mixture does not contain compounds selected from the group consisting of CaO, Ca(OH)₂, MgO, and Mg(OH)₂; and 100 parts of aqueous silicate, comprising: 1-35 parts silicate; and 99 to 65 parts water.

In one embodiment, a composition for consolidating and mechanically strengthening soil and/or sand comprises: 100 parts of a dry mixture, comprising: 99-1 parts of the soil and/or sand; 0-25 parts alumina; and 0-25 parts CaCl₂, and 100 parts of aqueous silicate, comprising: 1-35 parts silicate; and 99 to 65 parts water.

In one embodiment, the silicate in the composition for consolidating and mechanically strengthening soil and/or sand is Na₂Si₂O₃, Li₂Si₂O₃, and K₂Si₂O₃.

In one embodiment, the mixture of soil and/or sand, dry rock salt and alumina may be a dry mixture.

In one embodiment, the composition may be limited by excluding CaO (lime), so the consolidated and mechanically strengthened composition does not become as rigid and brittle as concrete.

### EXAMPLE 1

### Preparation of Consolidated and Mechanically Strengthened Soil and/or Sand using a Ratio w/w of Sand, CaCl₂ 25%, Alumina 25% and 100% v/v of a Sodium Silicate Solution Having 15%-30% w/w Sodium Silicate

Sand having a particle size between silt and pebbles ( 1/16 to 2 mm) was mixed with calcium chloride 25% w/w, aluminum oxide 25% w/w and 100% v/v of 15% aqueous sodium silicate solution. The sand, calcium chloride and aluminum oxide were combined and mixed while dry. The sodium silicate solution was then rapidly applied to the aforementioned mixture in an apparatus that allowed for facile drainage. After the sodium silicate solution had fully penetrated the surface of the sand (no solution above the surface of the sand), an equal volume of water was applied.

Consolidation or Impermeability Test: The water penetrated the “soil” much more slowly than the aqueous silicate solution (indicating a rapid reduction of hydraulic conductivity had occurred). After a period of 12 h, the sample was exposed to pressures of approximately 50 psi and, unlike the untreated wet sand, showed no mechanical deformation.

Mechanical Strength Test: The mechanical strength of the treated sample increased over 24 h, showing no deformation to >100 psi forces.

Hydraulic Conductivity Test: At the 24 h time point the sample was tested for hydraulic conductivity using a 3″ head of water. No flow of water through the sample was detected over a 1 h observation period.

### EXAMPLE 2

### Preparation of Consolidated and Mechanically Strengthened Soil and/or Sand using a Ratio w/w of Sand, CaCl₂ 25%, and 100% v/v of a Sodium Silicate Solution Having 15%-30% w/w Sodium Silicate

An “Al₂O₃ free” comparator sample was prepared with sand, calcium chloride 25% w/w and 100% v/v of 15% aqueous sodium silicate (omitting the aluminum oxide). The calcium chloride and sand were thoroughly mixed and the sodium silicate solution was applied as before.

Hydraulic Conductivity Test: Water was then added to the sample (as above), as for the composition including aluminum oxide, the sample developed a significantly decreased hydraulic conductivity.

Mechanical Strength Test: After 12 h the sample was exposed to approximately 50 psi and showed resistance to mechanical deformation in a top “boundry layer” (a layer of about 20% depth of the sample total), but became progressively less resistant to mechanical pressure as the vertical depth of sample was increased. The approximately bottom 20% of the sample had resistance to mechanical deformation similar to a “wet sand” comparator, and could be easily deformed with a 50 psi clamping force. This did not change over 24 h.

Use of either granulated or bead (3-4 mm) or pellet shaped calcium chloride as supplied commercially did not result in a noticeable difference in relative Consolidation or Mechanical Strength Test results.

Preparations were made varying the added amounts of calcium chloride, aluminum oxide and aqueous sodium silicate. Results as follows:
Reduction or increases in the proportion of aluminum oxide from that stated above (007) resulted in a loss of mechanical strength, as shown in the comparison of Examples 1 and 2.
Reduction in the proportion of calcium chloride from stated above (007) resulted in a loss of mechanical strength
Increased (up to 2×) amounts of calcium chloride from stated above (007) did not change results
Higher aqueous sodium silicate concentrations resulted in nonhomogeneous reaction within the sample as evidenced by inconsistent mechanical strength throughout the sample.

NaCl as a by-product of reaction in ground may be purged from the consolidated soil and/or sand during reaction of the sodium silicate with CaCl₂ when water percolates through the consolidated soil and/or sand as long as the ground remains porous.

Applications for consolidated soil and/or sand having increased mechanical strength are as follows:
a. use for onsolidation and increased mechanical strength of road surfaces for unimproved roads or unimproved landing strips;
b. use for permafrost solidification;
c. use to solidify ground around drilling stations or well sites where ground is soft;
d. use as fill into sink holes;
e. use to seal leaks in bore hole casings, reducing leaking of the casings to the surroundings, for securing the integrity of wells and borings, as for example during hydrofracking, to prevent process water used in hydrofracking from escaping from the hydrofracking process and contaminating the environment;
f. use to seal a holding pond for the contaminated water from hydrofracking; and
g. use to seal or entomb low level waste (LLW).

In one embodiment, step injection may be used to produce the consolidated soil and/or sand to seal leaks in bore hole and well casings, reducing leaking of the casings for securing bore hole drillings as in the hydrofracking process.

During hydrofracking, if water rises to the surface, or to shallow depths, methane may be separated. The water needs to be isolated to prevent contamination of the environment. Consolidation of soil and/or sand may be used to seal a holding pond for the contaminated water. Then the contaminated water may be pumped out of the holding pond and treated.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiments, methods, and examples, but by all embodiments and methods within the scope and spirit of the invention.

1. A method for consolidating and mechanically strengthening soil and/or sand, comprising:
a) Preparing a dry mixture, comprising: the soil and/or sand, CaCl₂ or CaO, and alumina,
wherein 100 parts of the dry mixture comprises
1-99 parts soil and/or sand,
0-25 parts CaCl₂ or CaO, and
0-25 parts alumina; and
b) adding aqueous silicate,
wherein 100 parts of the aqueous silicate comprises
1-35 parts silicate, and
99 to 65 parts water; and
c) repeating steps a and b until refusal occurs.

2. The method of claim 1, wherein the 100 parts of the aqueous silicate comprises 1-30 parts Na₂SiO₃, and 99 to 70 parts water.

3. The method of claim 1, wherein the silicate is selected from the group consisting of Na₂Si₂O₃, Li₂Si₂O₃, and K₂Si₂O₃.

4. The method of claim 1, comprising:
adding water to purge chloride by-product by percolation of water through the consolidated soil and/or sand for as long as the ground remains porous.

5. The method of claim 1, wherein the method is selected for consolidation of soil and/or sand for one of the following uses:
a. use for consolidation and increased mechanical strength of road surfaces for unimproved roads or unimproved landing strips;
b. use for permafrost solidification;
c. use for solidification of ground around drilling sites where ground is soft;
d. use as fill into sink holes;
e. use to seal leaks in bore hole casings, reducing leaking of the casings into the surroundings, for securing the integrity of wells and borings, as for example during hydrofracking, to prevent process water used in hydrofracking from escaping from the hydrofracking process and contaminating the environment;
f. use to seal a holding pond for the contaminated water from hydrofracking; and
g. use to seal or entomb low level waste (LLW).

6. A method for consolidating and mechanically strengthening soil and/or sand, comprising:
a) preparing a dry mixture comprising: the soil and/or sand, alumina, and CaCl₂,
wherein 100 parts of the dry mixture comprises
1-99 parts soil and/or sand,
0-25 parts CaCl₂ or CaO, and
0-25 parts alumina,
wherein the dry mixture does not contain compounds selected from the group consisting of CaO, Ca(OH)₂, MgO, and Mg(OH)₂;
b) adding aqueous silicate,
wherein 100 parts of the aqueous silicate comprises
1 to 35 parts silicate, and
99 to 65 parts water; and
c) repeating steps a and b until refusal occurs, so that the mixture or
treated mass becomes solidified, wherein substantially no concrete, as defined in the trade or commercially as a product by reactions with lime (CaO), is formed.

7. The method of claim 6, wherein the 100 parts of the aqueous silicate comprises 1-30 parts Na₂SiO₃, and 99 to 70 parts water.

8. The method of claim 6, wherein the silicate is selected from the group consisting of Na₂Si₂O₃, Li₂Si₂O₃, and K₂Si₂O₃.

9. A composition of consolidating and mechanically strengthening soil and/or sand, comprising:
100 parts of a dry mixture, comprising:
99-1 parts of the soil and/or sand;
0-25 parts alumina; and
0-25 parts CaCl₂,
wherein the dry mixture does not contain compounds selected from the group consisting of CaO, Ca(OH)₂, MgO, and Mg(OH)₂; and
100 parts of aqueous silicate, comprising:
1-35 parts silicate; and
99 to 65 parts water.

10. The composition of claim 9, wherein the 100 parts of the aqueous silicate comprises 1-30 parts Na₂SiO₃, and 99 to 70 parts water.

11. The composition of claim 9, wherein the silicate is selected from the group consisting of Na₂Si₂O₃, Li₂Si₂O₃, and K₂Si₂O₃.

12. A composition for consolidating and mechanically strengthening soil and/or sand, comprising:
100 parts of a dry mixture, comprising:
99-1 parts of the soil and/or sand;
0-25 parts alumina; and
0-25 parts CaCl₂, and
100 parts of aqueous silicate, comprising:
1-35 parts silicate; and
99 to 65 parts water.

13. The composition of claim 12, wherein the 100 parts of the aqueous silicate comprises 1-30 parts Na₂SiO₃, and 99 to 70 parts water.

14. The composition of claim 12, wherein the aqueous silicate is selected from the group consisting of Na₂Si₂O₃, Li₂Si₂O₃, and K₂Si₂O₃.

15. A method for consolidating and mechanically strengthening soil and/or sand, comprising:
a. preparing a dry mixture, comprising: the soil and/or sand, CaCl₂ or CaO, silicate and alumina,
wherein 100 parts of the dry mixture comprises
1-99 parts soil and/or sand,
0-25 parts CaCl₂ or CaO,
0-25 parts alumina, and
1-35 parts silicate; and
b) percolating water through the mixture; and
d) repeating steps a and b until refusal occurs.

16. The method of claim 15, wherein the 100 parts of the dry mixture comprises 1-30 parts Na₂SiO₃.

17. The method of claim 15, wherein the silicate is selected from the group consisting of Na₂Si₂O₃, Li₂Si₂O₃, and K₂Si₂O₃.

18. The method of claim 15, comprising:
adding water to purge chloride by-product by percolation of water through the consolidated soil and/or sand for as long as the ground remains porous.

19. The method of claim 15, wherein the method is selected for consolidation of soil and/or sand for one of the following uses:
a. use for consolidation and increased mechanical strength of road surfaces for unimproved roads or unimproved landing strips;
b. use for permafrost solidification;
c. use for solidification of ground around drilling sites where ground is soft;
d. use as fill into sink holes;
e. use to seal leaks in bore hole casings, reducing leaking of the casings into the surroundings, for securing the integrity of wells and borings, as for example during hydrofracking, to prevent process water used in hydrofracking from escaping from the hydrofracking process and contaminating the environment;
f. use to seal a holding pond for the contaminated water from hydrofracking; and
g. use to seal or entomb low level waste (LLW).

20. A composition for consolidating and mechanically strengthening soil and/or sand, comprising:
100 parts of a dry mixture, comprising:
99-1 parts of the soil and/or sand;
0-25 parts alumina;
1-35 parts silicate; and
0-25 parts CaCl₂.

21. The composition of claim 20, wherein the silicate is 1-30 parts Na₂SiO₃.

22. The composition of claim 20, wherein the silicate is selected from the group consisting of Na₂Si₂O₃, Li₂Si₂O₃, and K₂Si₂O₃.
